(19) United States
(12) Patent Application Publication
(10) Pub. No.: US 2021/0042681 A1
(43) Pub. Date: Feb. 11, 2021

(54) LEADERSHIP DEVELOPMENT OPTIMIZATION

(71) Applicant: Qulture, Inc., San Francisco, CA (US)

(72) Inventors: Francisco Souza Homem de Mello, San Francisco, CA (US); Frederico Augusto Vieira Campos de Castro, San Francisco, CA (US); João Batista Marinho, San Francisco, CA (US)

(21) Appl. No.: 16/985,193

(22) Filed: Aug. 4, 2020

Related U.S. Application Data
(60) Provisional application No. 62/885,193, filed on Aug. 9, 2019.

(51) Int. Cl. G06Q 10/06

(52) U.S. Cl. CPC G06Q 10/06398; G06Q 10/063118

(57) ABSTRACT

Methods, systems, and devices are provided for a leadership assessment and development system configured to improve leadership. According to one aspect, the system can receive a first leadership event based on a leadership information from a performance database in a computer-implemented server. The system can determine a first assiduity level associated with the first leadership event. The system can assign a first leadership score based on at least the first assiduity level associated with the first leadership event. And the system can display the leadership score on an electronic device.

### CROSS-REFERENCE TO RELATED APPLICATIONS

This application claims the benefit of U.S. Provisional Application No. 62/885,193, filed Aug. 9, 2019, which is hereby incorporated by reference in its entirety.

### BACKGROUND

Within organizations, various events and activities are conducted throughout a period for the purpose of developing the performance of its employees. For example, an event or activity can include performance reviews given by managers of an organization to the managers' direct reports for the purpose of evaluating and improving work-related performance in the organization and for identifying potential promotions for employees in the organization.

Organizations, such as companies, constantly desire to improve the leadership skills of the organizations' managers. The quality of leadership is correlated by many studies with organizational performance and employee engagement. Currently, organizations conduct performance reviews and assess leadership quality for certain individuals in an organization by a slow and manual process of requesting feedback from managers' direct reports on, among other things, the effectiveness and interactions between direct reports and their managers.

### BRIEF SUMMARY

The present disclosure relates generally to systems and methods for leadership assessment and development in an organizational management setting. In one aspect, a management system can be configured to improve leadership quality. According to one aspect, the system can receive a first leadership event based on a leadership information from a performance database in a computer-implemented server. The system can determine a first assiduity level associated with the first leadership event. The system can assign a first leadership score based on at least the first assiduity level associated with the first leadership event. And the system can display the leadership score on an electronic device.

In one aspect, the system can receive a second leadership event based on the leadership information from the performance database. The system can determine a second assiduity level associated with the second leadership event. And the system can assign a second leadership score based on at least, in part, the second assiduity level associated with the second leadership event.

In one aspect, the system can determine a first quality level associated with the first leadership event and assign the first leadership score based on at least, in part, the first quality level associated with the first leadership event.

In one aspect, the first leadership event can be based on one or more performance reviews given by a manager to a subordinate of the manager. In one aspect, the first assiduity level associated with the first leadership event can be based on a percentage of performance reviews given and a percentage of performance reviews expected.

In one aspect, the first leadership event can include one or more one-on-one meeting between a manager and a subordinate of the manager. In one aspect, the first assiduity level associated with the first leadership event can be based on a percentage of one-on-one meetings given and a percentage of one-on-one meetings expected.

In one aspect, the first leadership event can include one or more feedbacks given by a manager to a subordinate of the manager. In one aspect, the first assiduity level associated with the first leadership event can be based on a percentage of feedbacks given and a percentage of feedbacks expected.

In one aspect, the first leadership event can include one or more goals assigned by a manager and given to a subordinate of the manager. In one aspect, the first assiduity level associated with the first leadership event can be based on a percentage of goals assigned by the manager and a percentage of goals expected to be assigned by the manager.

In one aspect, the first leadership event can include one or more engagement scores assigned by a subordinate of a manager to the manager. And in one aspect, the first leadership event can include a level of turnover of employees associated with a manager.

In one aspect, the first leadership event can be based on one or more performance reviews given by a manager to a subordinate of the manager. In one aspect, the first quality level associated with the first leadership event can be based on a level of detail of the one or more performance reviews, a level of actionable items in the one or more performance reviews, a level of constructive feedback based on the one or more performance reviews, or a combination thereof.

In one aspect, the first leadership even can include one or more one-on-one meetings between a manager and a subordinate of the manager. In one aspect, the first quality level associated with the first leadership event can be based on a quality level of the one or more one-on-one meetings determined by the subordinate of the manager, quality level of the one or more one-on-one meetings determined by the computer-implemented server, or a combination thereof

In one aspect, the first leadership event can include one or more feedbacks given by a manager to a subordinate of the manager. In one aspect, the first quality level associated with the first leadership event can be based on a level of detail of the one or more feedbacks, a level of actionable items in the one or more feedbacks, a level of constructive feedback based on the one or more feedbacks, or a combination thereof

In one aspect, the first leadership event can include one or more goals assigned by a manager and given to a subordinate of the manager. In one aspect, the first quality level associated with the first leadership event can be based on a quality level of the one or more goals as determined by the subordinate of the manager, as determined by the computer-implemented server, or a combination thereof.

In one aspect, the system can assign an overall leadership score based on at least the first leadership score and second leadership score.

In one aspect, the system can generate one or more recommendations based on at least, in part, the first leadership score, the second leadership score, and the overall leadership score. In one aspect, the one or more recommendations can include conducting one-on-one meetings, giving feedback with constructive attributes, assigning goals, conducting performance reviews having constructive attributes, or a combination thereof.

In one aspect, the system can generate one or more recommendations based on the first leadership event and first leadership score.

Other embodiments are directed to systems and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

Illustrative embodiments are described with reference to the following figures.

FIG. 1 is a schematic illustration of a computer system for managing and optimizing leadership.

FIG. 2 shows an additional schematic illustration of the computer system for managing and optimizing leadership to certain aspects according to FIG. 1.

FIG. 3 illustrates a flow chart of an example process for optimizing leadership in accordance with various aspects of the subject technology.

FIG. 4 illustrates an additional flow chart of an example process for optimizing leadership in accordance with various aspects of the subject technology.

FIG. 5 illustrates an additional flow chart of an example process for optimizing leadership in accordance with various aspects of the subject technology.

FIG. 6 illustrates a diagram of a graphical user interface that can be displayed on a display device for optimizing and managing leadership.

FIG. 7 illustrates an additional diagram of a graphical user interface that can be displayed on a display device for optimizing and managing leadership.

### DETAILED DESCRIPTION

According to certain embodiments, methods and systems disclosed herein relate to a schedule generator.

In this specification, reference is made in detail to specific embodiments of the invention. Some of the embodiments or their aspects are illustrated in the figures. For clarity in explanation, the system has been described with reference to specific embodiments, however it should be understood that the system is not limited to the described embodiments. On the contrary, the system covers alternatives, modifications, and equivalents as may be included within its scope as defined by any patent claims. The following embodiments of the system are set forth without any loss of generality to, and without imposing limitations on, the claimed method. In the following description, specific details are set forth in order to provide a thorough understanding of the present method. The present method may be practiced without some or all of these specific details. In addition, well known features may not have been described in detail to avoid unnecessarily obscuring the system.

In addition, it should be understood that steps of the exemplary system and method set forth in this exemplary patent can be performed in different orders than the order presented in this specification. Furthermore, some steps of the exemplary system and method may be performed in parallel rather than being performed sequentially.

A computer implemented system and method for improving management and leadership in organizations is described.

One aspect of promoting positive growth in an organization is the improvement of leadership among managers and the improvement of relationships between managers, or any individual in organizations that have peers or subordinates, or both.

In one example of the described invention, a computer implemented performance management system, or leadership management system, is configured to improve characteristics of leadership of individuals within an organization by implementing an automated leadership management.

In one example of the described invention, a leadership score is generated by a computer implement leadership management system that allows organizations using the leadership management system to quickly evaluate an individual's leadership characteristics with a score derived from leadership information within the organization based, in part, on interactions of the individual with others. In one example, a recommendation can be automatically determined and generated for the individual to improve the individual's leadership characteristics. The recommendation can be based on the leadership score or scores of the individual and generated based, in part, on improving the individual's leadership score or scores.

### A. System Architecture

The following describes a system architecture configured to optimize leadership within an organization.

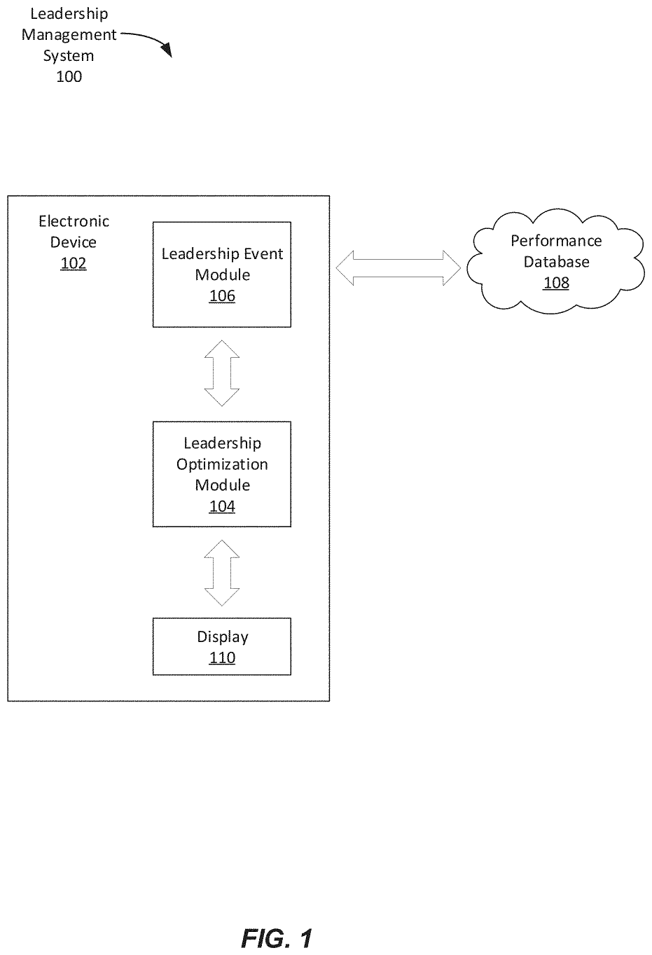

FIG. 1 illustrates a schematic of a computer implemented leadership management system for optimizing leadership in an organization. As illustrated in FIG. 1, a leadership management system 100 includes an electronic device 102 having a leadership event module 106, a leadership optimization module 104, and a display 110. The electronic device 102 can receive and send leadership information via the leadership even module 106 to a remote server, or performance database 108 configured to store leadership information gathered by an organization or by an individual interfacing with the electronic device 102. In one example, leadership information configured to determine and evaluate leadership events by the leadership event module 106 can also be stored internally in the electronic device 102. In one example, the electronic device 102 can be a mobile device such as a smart phone or a computer tablet. In one example, the electronic device can be any electronic device that can be interacted with a person such as a laptop or computer.

In one example, the leadership management system 100 is configured to assist an individual or organization to improve and optimize leadership and management of the organization or improve and optimize leadership and management characteristics of the individual, or both. In one example, the individual can be a manager or a person with managerial responsibilities in an organization. In one example, the organization can be a company comprised of executives, leaders, managers, and employees. The managers can have subordinates, for example, direct reports to the manager, or subordinates to the direct reports to the manager.

In one example, the leadership management system 100 is configured to generate a leadership score of individuals within the organization. In one example, the leadership management system 100 is configured to generate and display recommendations to individuals based on leadership characteristics and qualities of individuals and the leadership score or scores of the individuals.

According to the leadership management system 100 of FIG. 1, at the leadership event module 106 of electronic device 102, the leadership event module 106 can receive a first leadership event based on a leadership information from the performance database 108. In one example, leadership information can be associated with interactions, activities, evaluations, or a combination thereof between individuals of an organization or assessment of the organization by an individual. The information can be written information detailing the content of the interaction or evaluation or can be selectable levels of quality or quantity of the interaction. For example, leadership information can be associated with performance reviews given by an individual to another individual, such as a manager to the manager's direct report. The leadership information can be associated with goals set for an individual or company. The leadership event module 106 can categorize each of the different types of leadership information into leadership events. For example, a leadership event can be associated with a performance review given in a period of time within the organization. In one example, the leadership event can be associated with multiple performance reviews given by one manager to the manager's direct reports.

The leadership management system 100, at the leadership event module 106, can determine an assiduity level associated with various leadership events. The assiduity level can be portrayed, for example, by a ratio of percentage of a task completed by a percentage of a task expected. In one example, the first leadership event can be based on one or more performance reviews given by a manager to a subordinate of the manager. In this example, the first assiduity level can be based on a percentage of performance reviews given and a percentage of performance reviews expected. The performance reviews can be attributed to performance reviews given by a manager to the manager's direct reports.

In one example, the leadership optimization module 104, can receive information from the leadership events such as the category, quality and assiduity level of the leadership event (described in detail further below) and assign a first leadership score based on characteristics of the leadership event. For example, the leadership optimization module 104 of the leadership management system 100 can generate the leadership score based on an assiduity level having a numerical value such that a high assiduity level can be associated with a high leadership score assigned and a low numerical value for an assiduity level associated with a low leadership score.

In one example, multiple leadership scores can be assigned and generated from detecting multiple types of leadership events.

In one example, the system can assign a second leadership score based on at least, in part, an assiduity level or quality level (described in detail further below) associated with the different leadership event. In one example, the second leadership event can be that of a different type of leadership event from the first leadership event. For example, a leadership event can be associated with a performance review such that the computer implemented leadership management system 100 determines an assiduity level or quality level, or both, of the performance review and assigns the leadership score with the particular performance review. In another example, a first leadership score can be determined by evaluating multiple performance reviews such that the first leadership event is associated with multiple performance reviews. In another example, the second leadership event can be associated with goals, such as OKR's. The leadership management system 100 can determine an assiduity level or quality level, or both, of the goals or OKR's set by a manager or the company. In this example, a second leadership score can be determined based on the OKR. In another example, the second leadership score can be determined based on multiple OKR's. In another example, a leadership score can be assigned to each individual leadership event of a single type. For example, multiple leadership scores can be assigned to the leadership event associated with performance reviews such that each performance review in the leadership event can be assigned its own leadership score. The leadership management system 100 can then assign a different leadership score based on each of the multiple leadership scores.

In another example, the system can assign an overall leadership score based on at least the first leadership score and second leadership score, and possibly more leadership scores associated with different leadership events. In one example, the overall leadership score can reflect the overall leadership status of a particular individual, for example, a manager, based on different assiduity and quality of multiple and different leadership events.

In one example, more than one leadership score can be assigned based on the number of different types of leadership events detected. The leadership events associated with on-on-one meetings, performance reviews, feedback, praise, recognition, goals, OKR' s, engagement scores, evaluation scores, and turnovers are illustrative examples only and are not exhaustive in detecting unique and different types of leadership events.

In one example, the leadership optimization module 104 can assign a leadership score based on both the first assiduity level associated with the first leadership event and the first quality level associated with the same first leadership event. For example, a single leadership score associated with a manager's goals for the manager's direct reports based on the assiduity of the goals and the quality of the goals. For example, the leadership optimization module 104 can evaluate both the percentage of goals set to be given are met and the quality of goals such as how clear the goals are. The clarity of the goals can be automatically determined by the computer implemented system by analyzing any written information or leadership information data stored in a server associated with the leadership management system 100. The clarity of the goals can also be determined by direct feedback on the quality of the goals by any direct report's written feedback of the goals or any selected level of quality of goals that can be selected by the direct report. For example, a user interface for the direct report can indicate and ask for selection of the goal given to the direct report as having a “good” quality or “bad” quality or “neutral” quality. The selection can also be a numerical selection.

In one example, the electronic device 102 of the leadership management system 100 can display the leadership score or scores on the display 110.

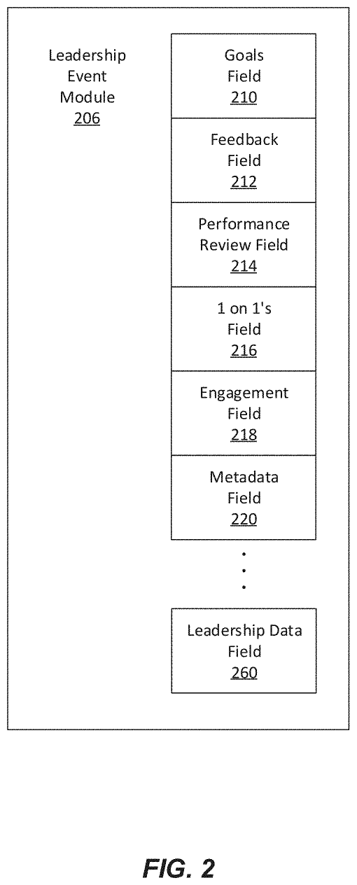

FIG. 2 illustrates a schematic of a leadership event module 206 similar to that of leadership event module 106 of FIG. 1. As illustrated in FIG. 2, leadership event module 206 can receive leadership information and categorize and evaluate the characteristic of each leadership event detected.

In one example, the leadership event module 206 can include a performance review field 214 for detecting leadership information related to performance reviews. In one example, the leadership event can be based on one or more performance reviews given by a manager to a subordinate of the manager. The performance review field can detect an assiduity level or quality level, or both, of the performance review. In this example, the assiduity level can be based on a percentage of performance reviews given and a percentage of performance reviews expected. The performance reviews can be attributed to performance reviews given by a manager to the manager's direct reports. In one example, a performance review field 214 of leadership event module 206 can also determine a quality level associated with the first leadership event of performance review and assign the first leadership score based on at least, in part, the first quality level associated with the first leadership event. The first quality level can be portrayed, for example, by numerical value or weight assigned to the leadership event. The quality can be automatically determined by the leadership event module 206 or can be assigned or selected by person. In one example, a first leadership event can be based on one or more performance reviews given by a manager to a subordinate of the manager. In this example, the first quality level associated with the first leadership event can be based on a level of detail of the one or more performance reviews, a level of actionable items in the one or more performance reviews, a level of constructive feedback or neutral feedback, or both based on the one or more performance reviews, or a combination thereof. In one example, the level of detail, the level of actional items, and the level of constructive feedback can be automatically determined by the computer implemented leadership management system by evaluating any leadership information from any written feedback stored in a server or an electronic device of the leadership management system. In another example, the level of detail, the level of actional items, and the level of constructive feedback can be assigned or determined by a person, for example, assigned by a direct report of a manager who receives the feedback.

In one example, the leadership event module 206 can include a one-on-one meetings field or 1 on 1's field 216 for detecting and evaluating leadership information related to one-on-one meetings. In the example, the leadership event can include one or more one-on-one meeting between a manager and a subordinate of the manager. In this example, the first assiduity can be based on a percentage of one-on-one meetings given and a percentage of one-on-one meetings expected. The one-on-one meetings can be attributed to meetings conducted by a manager and the manager's direct report. In another example, the one-on-one meetings can be attributed to any two people conducting a meeting, at least partially, based on leadership and goals of the organization. The evaluation of the one-on-one meetings by the leadership event module 206 can be based on the coverage of topics discussed and the coverage of topics expected. The coverage of topics can include, but not limited to, career next steps, work feedback, work-life balance, personal life, expectations for the year or other given time period, etc. In one example, the first leadership event can include one or more one-on-one meetings between a manager and a subordinate of the manager. In this example, the first quality level associated with the first leadership event can be based on a quality level of the one or more one-on-one meetings determined by the subordinate of the manager, quality level of the one or more one-on-one meetings determined by the computer-implemented server, or a combination thereof In one example, the quality level can be automatically determined and assigned by the computer implemented leadership management system. The quality level of the one or more one-on-one meetings determined by the subordinate of the manager, and quality level of the one or more one-on-one meetings can be automatically determined by the computer implemented leadership management system by evaluating any leadership information from any written feedback stored in a server or an electronic device of the leadership management system. In another example, the quality level can be assigned or determined by a person, for example, assigned by a direct report of a manager who participated in the on-on-one meeting or meetings or by the manager who participated in the one-on-one meeting or meetings.

In one example, the leadership event module 206 can include a feedback field 212 for detecting and evaluating leadership information related to feedbacks given. In one example, the feedbacks given can be categorically separated from performance reviews such that the organization engages in activity for requesting and giving feedback outside the course of conducting formal performance reviews. In one example, the first leadership event can include one or more feedbacks given by a manager to a subordinate of the manager. In this example, the first assiduity level can be based on a percentage of feedbacks given and a percentage of feedbacks expected. The feedbacks can be attributed to feedbacks given by manager to the manager's direct report. In another example, the feedbacks given can be attributed to any person who has worked on a project with another person in the same organization. In one example, the feedbacks can be associated with praise feedbacks based on projects or performance reviews that are conduct on a regular basis according to the organization's policy. In one example, the feedback can be associated with constructive criticism feedbacks. In this example, the first quality level associated with the first leadership event can based on a level of detail of the one or more feedbacks, a level of actionable items in the one or more feedbacks, a level of constructive feedback based on the one or more feedbacks, or a combination thereof. The level of detail can be automatically perceived and determined by the computer implemented leadership management system based on any written data stored in the server or based on a selection of selectable levels of quality of the feedback selected by the person who received the feedback.

In one example, the leadership event module 206 can include a goals field 210 for detecting and evaluating leadership information related to goals. In one example, the leadership event can include one or more goals assigned by a manager and given to a subordinate of the manager. In this example, the first assiduity level can be based on a percentage of goals assigned by the manager and a percentage of goals expected to be assigned by the manager. In one example, the goals set can be attributed to self-goals set by an individual on a regular basis, for example, the basis being set by an organization's policy. In another example, the goals can be set by a manager towards the manager's direct report or further subordinate down the organization of the manager and the subordinate. The determination of a goal being met can be determined by the manager. In one example, the goals can be associated with Objectives and Key Results (“OKRs”). In one example, the first leadership event can include one or more goals assigned by a manager and given to a subordinate of the manager. In this example, the first quality level associated with the first leadership event can be based on a quality level of the one or more goals as determined by the subordinate of the manager, as determined by the computer-implemented server, or a combination thereof. The quality level of the goals can be automatically perceived and determined by the computer implemented leadership management system based on any written data stored in the server or based on a selection of selectable levels of quality of the feedback selected by the person who received the feedback. The selection by the user or the automatically determined quality level by the computer implemented leadership management system can be associated with or based on the clarity of the goals, the level of alignment with the overall company strategy, or alignment of “SMART” (Specific, Measurable, Assignable, Realistic, Time-related) guidelines. In one example, the goals can be associated with Objectives and Key Results (“OKRs”).

In one example, the leadership event module 206 can include an engagement field 218 for detecting and evaluating leadership information related to engagement. In the example, the leadership event can include one or more evaluation scores assigned by a subordinate of a manager to the manager. In this example, the evaluation scores can be determined by the leadership management system based an employee's written and stored data related to sentiment about the organization, about the employee's leaders or direct managers, or a combination thereof. In one example, the evaluation score can be based on an employee's written and stored data related to opinions about leaving or staying at the company. In another example, the evaluation score can be a numerical score given by an employee about the employee's direct manager or leaders, or overall company, or based on a combination thereof.

In one example, the leadership event module 206 can include a metadata field 220 for detecting and evaluating leadership information related to metadata relevant in evaluating an organizations overall growth and evaluating a particular individual or manager. In one example, the leadership event associated with the metadata field 220 can include a level of turnover of employees are associated with a manager. The turnover can be evaluated by a set period of time predetermined by the organization of the manager and the employees or an arbitrary time period.

In one example, the leadership event module 206 can include a leadership data field 260 illustrating other fields having leadership information characteristics different from that of the previously described leadership event fields.

In one example, the leadership optimization module 104 can generate one or more recommendations based on one or more leadership scores, an overall leadership score, or both. In this example, the one or more recommendations can include conducting one-on-one meetings, giving feedback with constructive attributes, assigning goals, conducting performance reviews having constructive attributes, or a combination thereof. Since each of the first or second or more leadership scores assigned can be associated with different leadership events, the leadership optimization module 104 can generate recommendations associated with the leadership events based on the leadership scores. For example, a first leadership score can be associated with performance reviews and a second leadership score can be associated with goals and the overall leadership score can be based on the first leadership score, the second leadership score, and more leadership scores based on other leadership events. In this example, if the first leadership score is low due to having a low quality, or assiduity, or both of the performance reviews and the second leadership score is high based on having clear, frequent, and helpful goals determined by either the computer implemented leadership management system automatically or evaluated by a person, the leadership management system can automatically generate at least one recommendation based on first leadership score, second leadership score, and overall leadership score. The recommendation can be based on, at least in part, due to the low second leadership score, or based on, at least in part, a threshold, either set by the company, by a manager, or a default setting to achieve or hit a certain overall leadership score. Alternatively, the leadership management system can generate one or more recommendations based on the first leadership event and first leadership score. For example, a recommendation for a higher quality performance review can be recommended by only evaluating the leadership score of a leadership event associated with performance review or reviews.

Examples of recommendations, based on leadership scores, or evaluation of assiduity and quality of leadership events, or both, can include, but not limited to, give more feedback, or praise, or recognition, or a combination thereof. The recommendations can include giving higher quality feedback, or praise, or recognition, or a combination there. The recommendations can include set clearer goals for each direct report, and to set more or fewer goals in a given time period. The recommendations can include engaging in more one-on-one meetings and discuss career development or goals. Another example of a recommendation can be of giving more constructive feedback. The described examples of recommendations above are illustrative only.

### B. Flow Diagrams

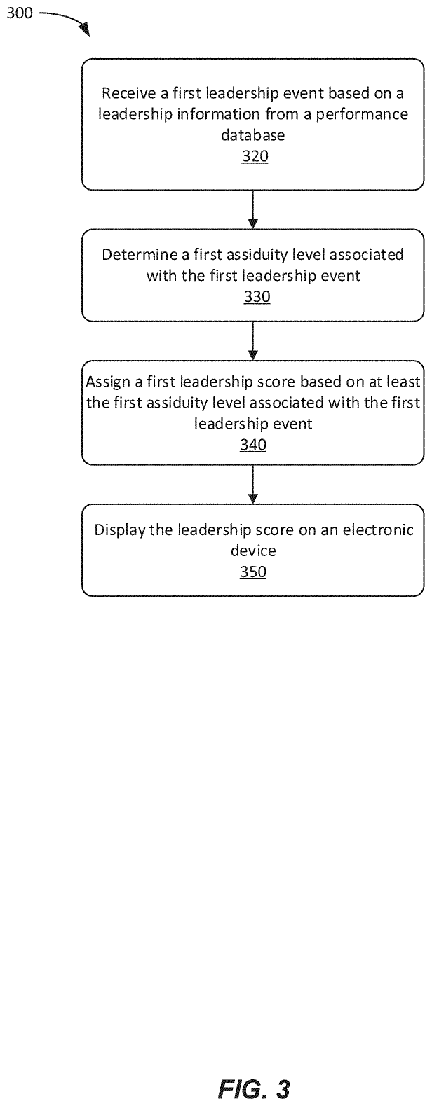

FIGS. 3-5 depicts flow diagrams of example processes for optimizing leadership in accordance with various aspects of the invention.

In the example flow diagram 300 of FIG. 3, at block 320, a computer-implemented system can receive a first leadership event based on a leadership information from a performance database in a computer-implemented server.

At block 330, the system can determine a first assiduity level associated with the first leadership event. The assiduity level can be portrayed, for example, by a ratio of percentage of a task completed by a percentage of a task expected. In one example, the first leadership event can be based on one or more performance reviews given by a manager to a subordinate of the manager. In this example, the first assiduity level can be based on a percentage of performance reviews given and a percentage of performance reviews expected. The performance reviews can be attributed to performance reviews given by a manager to the manager's direct reports. In another example, the first leadership event can include one or more one-on-one meeting between a manager and a subordinate of the manager. In this example, the first assiduity can be based on a percentage of one-on-one meetings given and a percentage of one-on-one meetings expected. The one-on-one meetings can be attributed to meetings conducted by a manager and the manager's direct report. In another example, the one-on-one meetings can be attributed to any two people conducting a meeting, at least partially, based on leadership and goals of the organization. In one example, the first leadership event can include one or more feedbacks given by a manager to a subordinate of the manager. In this example, the first assiduity level can be based on a percentage of feedbacks given and a percentage of feedbacks expected. The feedbacks can be attributed to feedbacks given by manager to the manager's direct report. In another example, the feedbacks given can be attributed to any person who has worked on a project with another person in the same organization. In one example, the feedbacks can be associated with praise feedbacks based on projects or performance reviews that are conduct on a regular basis according to the organization's policy. In one example, the feedback can be associated with constructive criticism feedbacks. In one example, the first leadership event can include one or more goals assigned by a manager and given to a subordinate of the manager. In this example, the first assiduity level can be based on a percentage of goals assigned by the manager and a percentage of goals expected to be assigned by the manager. In one example, the goals set can be attributed to self-goals set by an individual on a regular basis, for example, the basis being set by an organization's policy. In another example, the goals can be set by a manager towards the manager's direct report or further subordinate down the organization of the manager and the subordinate. The determination of a goal being met can be determined by the manager. In one example, the goals can be associated with Objectives and Key Results (“OKRs”). In one example, the first leadership event can include one or more evaluation scores assigned by a subordinate of a manager to the manager. In this example, the evaluation scores can be determined by the leadership management system based an employee's written and stored data related to sentiment about the organization, about the employee's leaders or direct managers, or a combination thereof. In one example, the evaluation score can be based on an employee's written and stored data related to opinions about leaving or staying at the company. In another example, the evaluation score can be a numerical score given by an employee about the employee's direct manager or leaders, or overall company, or based on a combination thereof. In one example, the first leadership event can include a level of turnover of employees associated with a manager. The turnover can be evaluated by a set period of time predetermined by the organization of the manager and the employees.

At block 340, the system can assign a first leadership score based on at least the first assiduity level associated with the first leadership event. The computer implemented system can generate the first leadership score based on an assiduity level, described above, having a numerical value such that a high assiduity level can be associated with a high leadership score assigned and a low numerical value for an assiduity level associated with a low leadership score.

And at block 350, the system can display the leadership score on an electronic device.

In one example, a computer implemented system can also determine a first quality level associated with the first leadership event and assign the first leadership score based on at least, in part, the first quality level associated with the first leadership event. The first quality level can be portrayed, for example, by numerical value or weight assigned to the leadership event. The quality can be automatically determined by the computer implemented leadership management system or can be assigned or selected by person. In one example, first leadership event can be based on one or more performance reviews given by a manager to a subordinate of the manager. In this example, the first quality level associated with the first leadership event can be based on a level of detail of the one or more performance reviews, a level of actionable items in the one or more performance reviews, a level of constructive feedback based on the one or more performance reviews, or a combination thereof. In one example, the level of detail, the level of actional items, and the level of constructive feedback can be automatically determined by the computer implemented leadership management system by evaluating any leadership information from any written feedback stored in a server or an electronic device of the leadership management system. In another example, the level of detail, the level of actional items, and the level of constructive feedback can be assigned or determined by a person, for example, assigned by a direct report of a manager who receives the feedback. In one example, the first leadership event can include one or more one-on-one meetings between a manager and a subordinate of the manager. In this example, the first quality level associated with the first leadership event can be based on a quality level of the one or more one-on-one meetings determined by the subordinate of the manager, quality level of the one or more one-on-one meetings determined by the computer-implemented server, or a combination thereof. In one example, the quality level can be automatically determined and assigned by the computer implemented leadership management system. The quality level of the one or more one-on-one meetings determined by the subordinate of the manager, and quality level of the one or more one-on-one meetings can be automatically determined by the computer implemented leadership management system by evaluating any leadership information from any written feedback stored in a server or an electronic device of the leadership management system. In another example, the quality level can be assigned or determined by a person, for example, assigned by a direct report of a manager who participated in the on-on-one meeting or meetings or by the manager who participated in the one-on-one meeting or meetings. In one example, first leadership event can include one or more feedbacks given by a manager to a subordinate of the manager. In this example, the first quality level associated with the first leadership event can based on a level of detail of the one or more feedbacks, a level of actionable items in the one or more feedbacks, a level of constructive feedback based on the one or more feedbacks, or a combination thereof. The level of detail can be automatically perceived and determined by the computer implemented leadership management system based on any written data stored in the server or based on a selection of selectable levels of quality of the feedback selected by the person who received the feedback. In one example, the first leadership event can include one or more goals assigned by a manager and given to a subordinate of the manager. In this example, the first quality level associated with the first leadership event can be based on a quality level of the one or more goals as determined by the subordinate of the manager, as determined by the computer-implemented server, or a combination thereof. The quality level of the goals can be automatically perceived and determined by the computer implemented leadership management system based on any written data stored in the server or based on a selection of selectable levels of quality of the feedback selected by the person who received the feedback. The selection by the user or the automatically determined quality level by the computer implemented leadership management system can be associated with or based on the clarity of the goals, the level of alignment with the overall company strategy, or alignment of “SMART” (Specific, Measurable, Assignable, Realistic, Time-related) guidelines. In one example, the goals can be associated with Objectives and Key Results (“OKRs”).

In one example, the computer implemented system can assign the first leadership score based on both the first assiduity level associated with the first leadership event and the first quality level associated with the same first leadership event. For example, a single leadership score associated with a manager's goals for the manager's direct reports based on the assiduity of the goals and the quality of the goals. For example, the computer implemented system can evaluate both the percentage of goals set to be given are met and the quality of goals such as how clear the goals are. The clarity of the goals can be automatically determined by the computer implemented system by analyzing any written information or leadership information data stored in a server associated with the computer implemented system. The clarity of the goals can also be determined by direct feedback on the quality of the goals by any direct report's written feedback of the goals or any selected level of quality of goals that can be selected by the direct report. For example, a user interface for the direct report can indicate and ask for selection of the goal given to the direct report as having a “good” quality or “bad” quality or “neutral” quality. The selection can also be a numerical selection.

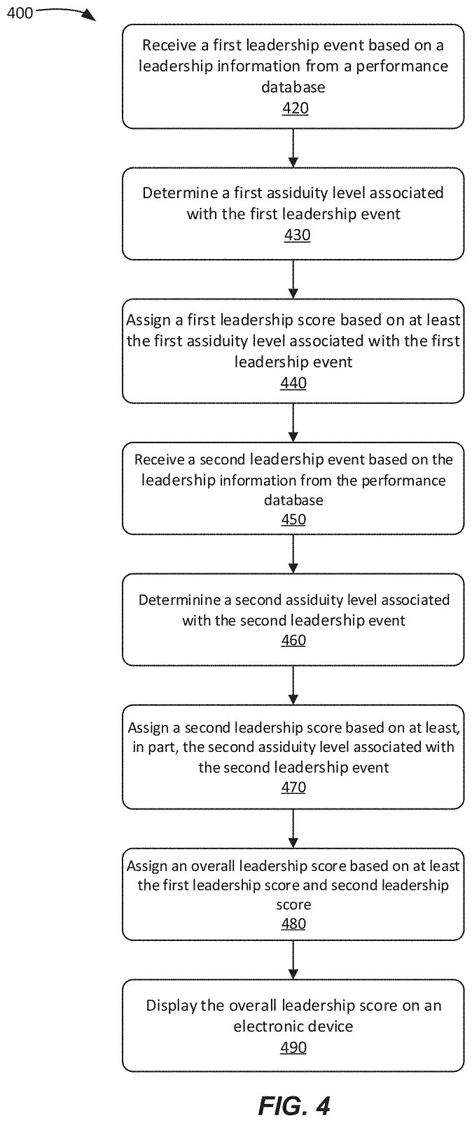

In the example flow diagram 400 of FIG. 4, at block 420, a computer-implemented system can receive a first leadership event based on a leadership information from a performance database in a computer-implemented server.

At block 430, the system can determine a first assiduity level associated with the first leadership event. At block 440, the system can assign a first leadership score based on at least the first assiduity level associated with the first leadership event.

At block 450, the system can receive a second leadership event based on the leadership information from the performance database.

At block 460, the system can determine a second assiduity level associated with the second leadership event.

At block 470, the system can assign a second leadership score based on at least, in part, the second assiduity level associated with the second leadership event. In one example, the second leadership event can be that of a different type of leadership event from the first leadership event. For example, a leadership event can be associated with a performance review such that the computer implemented leadership management system determines an assiduity level or quality level, or both, of the performance review and assigns the leadership score with the particular performance review. In another example, the first leadership score can be determined by evaluating multiple performance reviews such that the first leadership event is associated with multiple performance reviews. In another example, the second leadership event can be associated with goals, such as OKR's. The computer implemented leadership management system can determine an assiduity level or quality level, or both, of the goals or OKR's set by a manager or the company. In this example, the second leadership score can be determined based on the OKR. In another example, the second leadership score can be determined based on multiple OKR's. In another example, a leadership score can be assigned to each individual leadership event of a single type. For example, multiple leadership scores can be assigned to the leadership event associated with performance reviews such that each performance review in the leadership event can be assigned its own leadership score. The computer implemented leadership management system can then assign a different leadership score based on each of the multiple leadership scores.

At block 480, the system can assign an overall leadership score based on at least the first leadership score and second leadership score. In one example, the overall leadership score can reflect the overall leadership status of a particular individual, for example, a manager, based on different assiduity and quality of multiple and different leadership events.

In one example, more than one leadership score can be assigned based on the number of different types of leadership events detected. The leadership events associated with on-on-one meetings, performance reviews, feedback, praise, recognition, goals, OKR's, engagement scores and turnovers are illustrative examples only and are not exhaustive in detecting unique and different types of leadership events.

And at block 490, the system can display the overall leadership score on an electronic device.

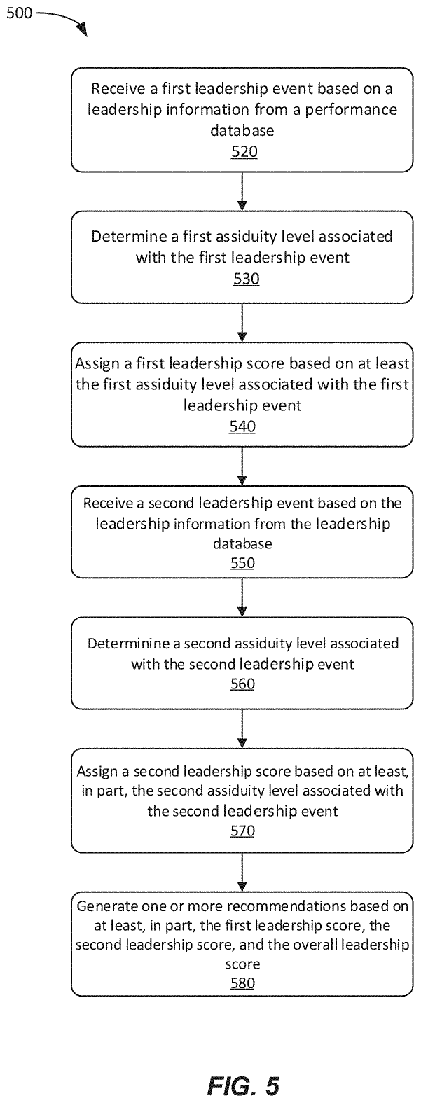

In the example flow diagram 500 of FIG. 5, at block 520, a computer-implemented system can receive a first leadership event based on a leadership information from a performance database in a computer-implemented server.

At block 530, the system can determine a first assiduity level associated with the first leadership event.

At block 540, the system can assign a first leadership score based on at least the first assiduity level associated with the first leadership event.

At block 550, the system can receive a second leadership event based on the leadership information from the performance database.

At block 560, the system can determine a second assiduity level associated with the second leadership event.

At block 570, the system can assign a second leadership score based on at least, in part, the second assiduity level associated with the second leadership event. In one example, the second leadership event can be that of a different type of leadership event from the first leadership event. For example, a leadership event can be associated with a performance review such that the computer implemented leadership management system determines an assiduity level or quality level, or both, of the performance review and assigns the leadership score with the particular performance review. In another example, the first leadership score can be determined by evaluating multiple performance reviews such that the first leadership event is associated with multiple performance reviews. In another example, the second leadership event can be associated with goals, such as OKR's. The computer implemented leadership management system can determine an assiduity level or quality level, or both, of the goals or OKR's set by a manager or the company.

In this example, the second leadership score can be determined based on the OKR. In another example, the second leadership score can be determined based on multiple OKR's. In another example, a leadership score can be assigned to each individual leadership event of a single type. For example, multiple leadership scores can be assigned to the leadership event associated with performance reviews such that each performance review in the leadership event can be assigned its own leadership score. The computer implemented leadership management system can then assign a different leadership score based on each of the multiple leadership scores.

And at block 580, the system can generate one or more recommendations based on at least, in part, the first leadership score, the second leadership score, and the overall leadership score. In this example, the one or more recommendations can include conducting one-on-one meetings, giving feedback with constructive attributes, assigning goals, conducting performance reviews having constructive attributes, or a combination thereof. Since each of the first or second or more leadership scores assigned can be associated with different leadership events, the computer implemented leadership management system can generate recommendations associated with the leadership events based on the leadership scores. For example, a first leadership score can be associated with performance reviews and a second leadership score can be associated with goals and the overall leadership score can be based on the first leadership score, the second leadership score, and more leadership scores based on other leadership events. In this example, if the first leadership score is low due to having a low quality, or assiduity, or both of the performance reviews and the second leadership score is high based on having clear, frequent, and helpful goals determined by either the computer implemented leadership management system automatically or evaluated by a person, the leadership management system can automatically generate at least one recommendation based on first leadership score, second leadership score, and overall leadership score. The recommendation can be based on, at least in part, due to the low second leadership score, or based on, at least in part, a threshold, either set by the company, by a manager, or a default setting to achieve or hit a certain overall leadership score. Alternatively, the leadership management system can generate one or more recommendations based on the first leadership event and first leadership score. For example, a recommendation for a higher quality performance review can be recommended by only evaluating the leadership score of a leadership event associated with performance review or reviews.

And the system can display the recommendation on an electronic device.

### C. Dashboard

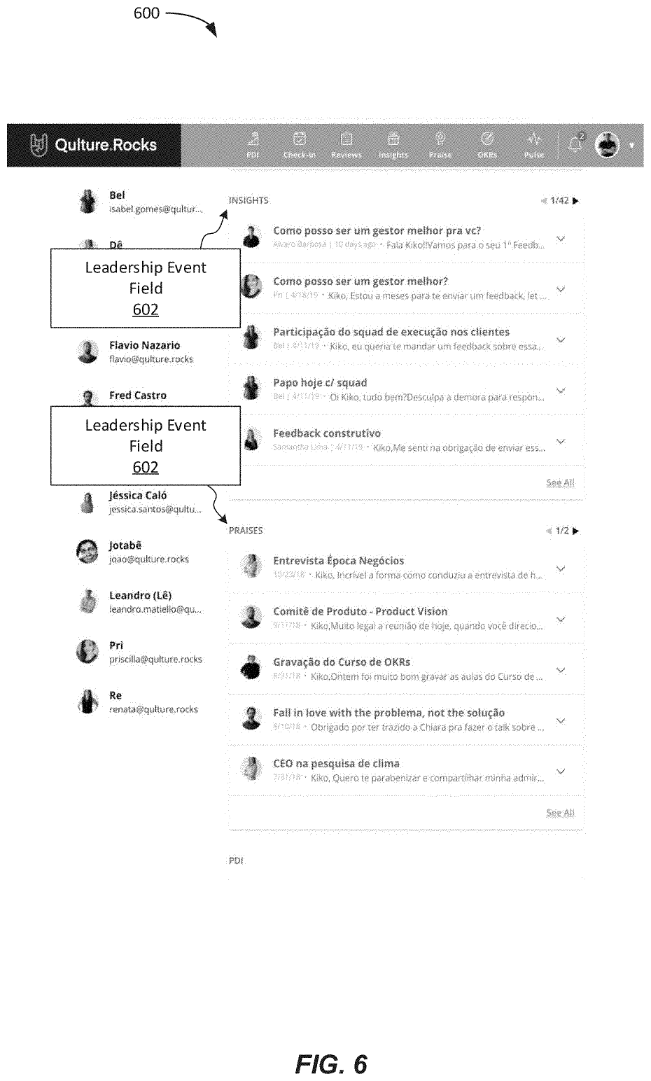

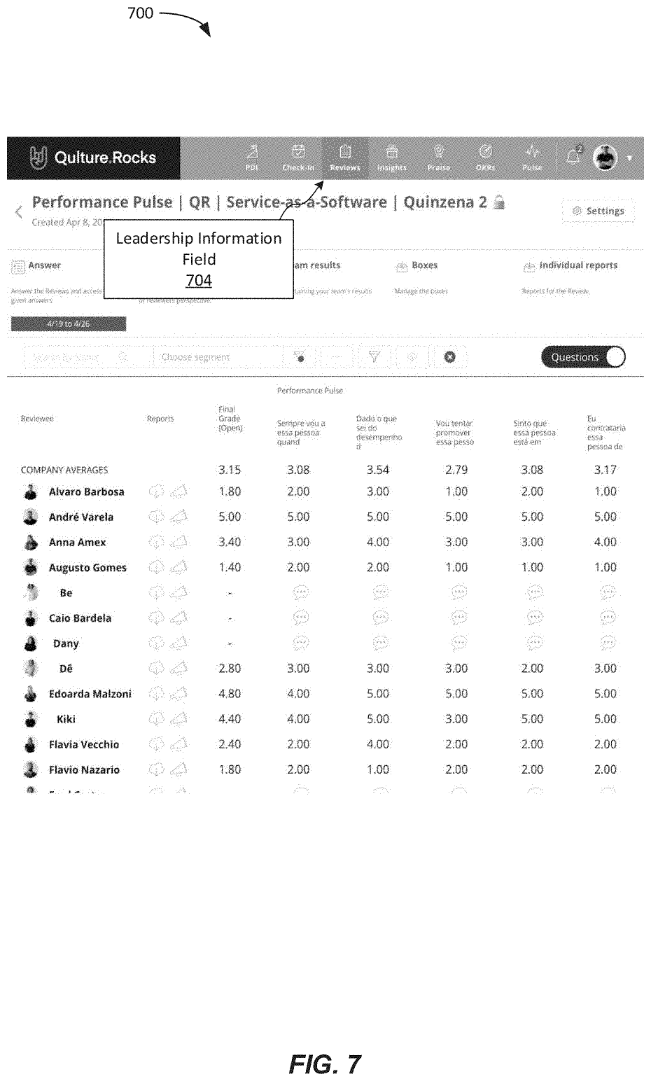

FIGS. 6-7 illustrate depictions of an example user interface with a computer dashboard for requesting, giving, and viewing leadership information. In one example, the dashboard is configured for a particular user, such as a manager or a leader of an organization.

As illustrated in FIG. 6, a dashboard 600 includes a homepage of a manager or leader having multiple leadership events fields, similar to the leadership events and illustrated in FIGS. 1 and 2. As illustrated in FIG. 6, the dashboard can include a personalized home page that has highlights. It can display a page for reviews. It can display a page for the current user's profile including any leadership event related to that particular user in leadership event fields 602. For example, the webpage showing the particular user's profile can display OKR's, insights, praises, PDI's, and so forth, such that each of the leadership event are events relating to the particular user. For example, A list of OKR's for the particular user can be displayed in an OKR field. In this example, the profile can be of a manager or leader and the praises field can be from direct reports or from colleagues. The praises section can include any praises received by the particular manager or leader. In one example, the insights field can display a summary of feedbacks given to the particular user and displayed in the insights field of the user's profile. The summary can be expanded to display a full review when the user selects the particular insight to review.

As illustrated in FIG. 7, the dashboard can also display various pages having different leadership information fields 704. In the example illustrated by FIG. 7, the leadership information field 704 is a reviews page, displaying each review the particular user has given for the user's colleagues or direct reports. In one example, reviews or performance reviews are used for promotion purposes. The reviews page can help the user indicate a potential candidate for promotion, or if the reviews itself and used in a pool of reviews and other leadership management metrics to decide promotions. This can be done with written feedback, or numerical evaluations, or both, of particular employees that the user, for example, a manager can determine. For example, a rating used for numerically assessing a score for performance reviews can be associated with how much the particular person being reviewed is dependent upon when an issue arises.

In one example, an insights page that allows the user to search, view, and give insights, which can include suggestions, reviews, praises and so forth can be displayed in a page. In one example, the request of an insight can be detected by the leadership management system. The leadership management system can receive the data associated with the request of an insight and assign the insight to a leadership event. As such, the leadership event field can be compiled with other leadership event fields to calculate a leadership score for the user.

In one example, the dashboard can display a praise page for the user to give praise. Each of the praises that the user gives can be displayed for the user in the praise page as well as the homepage for the user's profile. The praises will also be received by the leadership management system for generating a leadership event and evaluating the leadership event for generating a leadership score, or a recommendation, or both.

In one example, the dashboard can also display an OKR page. The page allows to enter, comment, and check progress on the OKR graph for the company and for the individual user. It can see who has viewed or edited the OKR's. The OKRs and OKR progress can also be used to generate a leadership events such that the progress of the OKR's can be used to determine the leadership score.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more embodiments, the computer readable media is non-transitory computer readable media, computer readable storage media, or non-transitory computer readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The word “exemplary” is used herein to mean “serving as an example or illustration.” Any aspect or design described herein as “exemplary” is not necessarily to be construed as preferred or advantageous over other aspects or designs. In one aspect, various alternative configurations and operations described herein may be considered to be at least equivalent.

As used herein, the phrase “at least one of” preceding a series of items, with the term “or” to separate any of the items, modifies the list as a whole, rather than each item of the list. The phrase “at least one of” does not require selection of at least one item; rather, the phrase allows a meaning that includes at least one of any one of the items, and/or at least one of any combination of the items, and/or at least one of each of the items. By way of example, the phrase “at least one of A, B, or C” may refer to: only A, only B, or only C; or any combination of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain.

It is understood that some or all steps, operations, or processes may be performed automatically, without the intervention of a user. Method claims may be provided to present elements of the various steps, operations or processes in a sample order, and are not meant to be limited to the specific order or hierarchy presented.

All structural and functional equivalents to the elements of the various aspects described throughout this disclosure that are known or later come to be known to those of ordinary skill in the art are expressly incorporated herein by reference and are intended to be encompassed by the appended claims. Moreover, nothing disclosed herein is intended to be dedicated to the public regardless of whether such disclosure is explicitly recited in the claims. No claims element is to be construed under the provisions of 35 U.S.C. § 112 (f) unless the element is expressly recited using the phrase “means for” or, in the case of a method, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a claim.

The Title, Background, Brief Description of the Drawings, and Claims of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in any claim. Rather, as the following claims s reflect, inventive subject matter lies in less than all features of a single disclosed configuration or operation. The following claims are hereby incorporated into the Detailed Description, with each claim standing on its own to represent separately claimed subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

What is claimed is:

1. A computer-implemented method of optimizing leadership, the method comprising:
receiving a first leadership event based on a leadership information from a performance database in a computer-implemented server;
determining a first assiduity level associated with the first leadership event;
assigning a first leadership score based on at least the first assiduity level associated with the first leadership event; and
displaying the leadership score on an electronic device.

2. The computer-implemented method of claim 1 further comprising:
receiving a second leadership event based on the leadership information from the performance database;
determining a second assiduity level associated with the second leadership event; and
assigning a second leadership score based on at least, in part, the second assiduity level associated with the second leadership event.

3. The computer-implemented method of claim 1 further comprising:
determining a first quality level associated with the first leadership event; and
assigning the first leadership score based on at least, in part, the first quality level associated with the first leadership event.

4. The computer-implemented method of claim 1 wherein the first leadership event is based on one or more performance reviews given by a manager to a subordinate of the manager.

5. The computer-implemented method of claim 4 wherein the first assiduity level associated with the first leadership event is based on a percentage of performance reviews given and a percentage of performance reviews expected.

6. The computer-implemented method of claim 1 wherein the first leadership event includes one or more one-on-one meeting between a manager and a subordinate of the manager.

7. The computer-implemented method of claim 6 wherein the first assiduity level associated with the first leadership event is based on a percentage of one-on-one meetings given and a percentage of one-on-one meetings expected.

8. The computer-implemented method of claim 1 wherein the first leadership event includes one or more feedbacks given by a manager to a subordinate of the manager.

9. The computer-implemented method of claim 8 wherein the first assiduity level associated with the first leadership event is based on a percentage of feedbacks given and a percentage of feedbacks expected.

10. The computer-implemented method of claim 1 wherein the first leadership event includes one or more goals set by a manager, or a subordinate of the manager, or both, for the subordinate of the manager.

11. The computer-implemented method of claim 10 wherein the first assiduity level associated with the first leadership event is based on a percentage of goals set for the subordinate of the manager and a percentage of goals expected to be set for the subordinate of the manager.

12. The computer-implemented method of claim 1 wherein the first leadership event includes one or more evaluation scores assigned by a subordinate of a manager to the manager.

13. The computer-implemented method of claim 1 wherein the first leadership event includes a level of turnover of employees managed by a manager.

14. The computer-implemented method of claim 3 wherein the first leadership event is based on one or more performance reviews given by a manager to a subordinate of the manager.

15. The computer-implemented method of claim 14 wherein the first quality level associated with the first leadership event is based on a level of detail of the one or more performance reviews, a level of actionable items in the one or more performance reviews, a level of constructive feedback based on the one or more performance reviews, or a combination thereof.

16. The computer-implemented method of claim 3 wherein the first leadership event includes one or more one-on-one meetings between a manager and a subordinate of the manager.

17. The computer-implemented method of claim 16 wherein the first quality level associated with the first leadership event is based on a quality level of the one or more one-on-one meetings determined by the subordinate of the manager, quality level of the one or more one-on-one meetings determined by the computer-implemented server, or a combination thereof.

18. The computer-implemented method of claim 3 wherein the first leadership event includes one or more feedbacks given by a manager to a subordinate of the manager.

19. The computer-implemented method of claim 18 wherein the first quality level associated with the first leadership event is based on a level of detail of the one or more feedbacks, a level of actionable items in the one or more feedbacks, a level of constructive feedback based on the one or more feedbacks, or a combination thereof.

20. The computer-implemented method of claim 3 wherein the first leadership event includes one or more goals set by a manager, or a subordinate of the manager, or both, for the subordinate of the manager.

21. The computer-implemented method of claim 2 further comprising assigning an overall leadership score based on at least the first leadership score and second leadership score.

22. The computer-implemented method of claim 22 further comprising generating one or more recommendations based on at least, in part, the first leadership score, the second leadership score, and the overall leadership score.

23. The computer-implemented method of claim 23 wherein the one or more recommendations include conducting one-on-one meetings, giving feedback with constructive attributes, assigning goals, conducting performance reviews having constructive attributes, or a combination thereof

24. The computer-implemented method of claim 1 further comprising generating one or more recommendations based on the first leadership event and first leadership score.
